(19) United States
(12) Patent Application Publication
(10) Pub. No.: US 2002/0029651 A1
(43) Pub. Date: Mar. 14, 2002

(54) Camshaft for the operation of valves of an internal-combustion engine

(76) Inventors: Gerold Sluka, Neckartailfingen (DE); Edwin Palesch, Lenningen (DE); Wolfgang Stephan, Boll (DE); Axel Willi Jochim, Nurtingen (DE); Andreas Knecht, Kusterdingen (DE)

Correspondence Address: CROWELL & MORING, LLP, 1200 G Street, N.W., Suite 700, Washington, DC, 20005, US

(21) Appl. No.: 09/900,456

(22) Filed: Jul. 9, 2001

(30) Foreign Application Priority Data
Jul. 7, 2000 (DE) 100 33 229.3

(51) Int. Cl. F16H 53/00

(52) U.S. Cl. 74/567

(57) ABSTRACT

A camshaft includes a device for hydraulic adjustment of a relative rotating position of the camshaft for the purpose of influencing valve timing. The device has a drive wheel, a cell wheel, and an impeller. The impeller is disposed, by way of vanes, within cells of the cell wheel and can carry out relative motion. A locking arrangement, which operates in the starting phase of the internal-combustion engine, is provided between the cell wheel and the impeller. The locking arrangement is formed by a spring-loaded, hydraulically operated piston housed in one of the blades of the impeller and by a corresponding receiving device for the piston provided in a constructional unit consisting of the drive wheel and the cell wheel. The piston of the vane interacting with the receiving device is acted upon from a pressure duct of the vane. A reversal valve in the pressure duct is connected to pressure spaces of one of the cells.

This application claims the priority of German application 100 33 229.3, filed Jul. 7, 2000, the disclosure of which is expressly incorporated by reference herein.

### BACKGROUND AND SUMMARY OF THE INVENTION

The present invention relates to a camshaft for the operation of valves of an internal-combustion engine including a device for hydraulic adjustment of a relative rotating position of the camshaft for influencing a timing of the valves. The device has a drive wheel for the camshaft, a cell wheel, and an impeller which can carry out a relative motion and is disposed with radial blades within cells of the cell wheel. A locking arrangement acts in a starting phase of the internal-combustion engine and is provided between the cell wheel and the impeller. The locking arrangement is formed by an axially spring-loaded, hydraulically operated piston housed in one of the blades of the impeller and a corresponding receiving device for the piston provided in a constructional unit consisting of the drive wheel and the cell wheel.

German Patent Document DE 39 37 644 A1 concerns a known camshaft of the type mentioned above. A locking arrangement is provided in this known camshaft. In the starting phase of the internal-combustion engine, the locking arrangement fixes the impeller relative to the cell wheel to avoid uncontrolled movements of the two wheels with respect to one another. Such movements can cause, among other things, disturbing sounds. The locking arrangement comprises a slidably movable locking sleeve arranged coaxially between the cell wheel and the impeller. The locking sleeve non-rotatably connects the above-mentioned wheels with one another in a first position and separates them from one another in a second position.

In German Patent Document DE 1 96 23 818 A1, a corresponding locking device is provided between a vane-type extension of an impeller and a cover of a cell wheel. The locking arrangement is provided with a spring-loaded, axially movable piston. In the starting phase of the internal-combustion engine, this piston engages in a receiving device of the cover.

It is an object of this invention to improve a locking arrangement of a device for adjusting the relative rotating position of a camshaft such that it can easily be integrated in the device and functions well.

According to the invention, this object is achieved by having the piston housed in one of the blades, which cooperates with a corresponding receiving device, acted upon by a pressure duct of the one of the blades. A reversal valve is operative in the pressure duct which is connected to pressure spaces of one of the cells. Additional characteristics and further developments of the invention are reflected in the claims.

The principal advantages achieved by the invention are that the pressure duct and the reversal valve ensure an excellent and, mainly because of the separate pressure spaces, immediate effect with respect to unlocking and locking of the locking arrangement for adjusting the relative rotating position of the camshaft. The pressure duct and the reversal valve can be integrated in a simple manner in the vane of the impeller of the device. The reversal valve, which comprises a ball movably disposed in the pressure duct, can be implemented with acceptable expenditures. In this case, the step bore and the insert contribute to making the ball easily mountable and advantageously limited. Finally, the piston, the pressure spring and the spring plate are components which can be produced at reasonable cost.

The drawings show an embodiment of the invention which will be described in detail.

### BRIEF DESCRIPTION OF THE DRAWINGS

FIG. 1 is a top view of a schematically illustrated internal-combustion engine with camshafts for the operation of valves;

FIG. 2 is an enlarged sectional view along line II-II of FIG. 1;

FIG. 3 is an enlarged view of a detail X of FIG. 2; and

FIG. 4 is a sectional view along line IV-IV of FIG. 3.

### DESCRIPTION OF THE PREFERRED EMBODIMENT

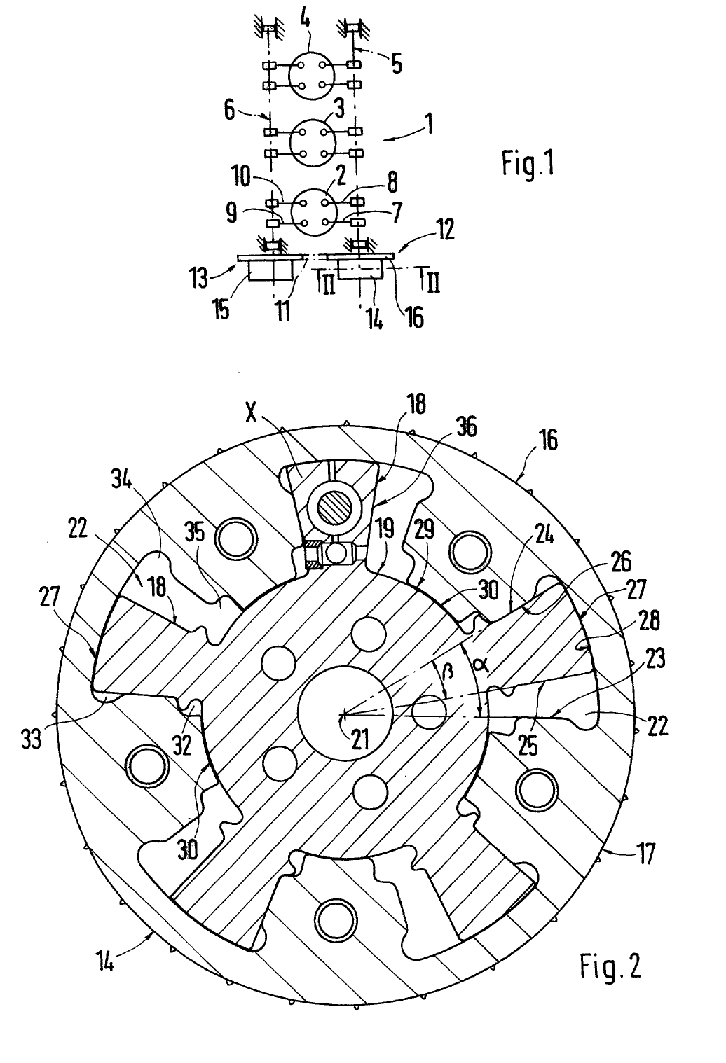

An internal-combustion engine 1 of the Otto type is shown in FIG. 1 and comprises several cylinders 2, 3 and 4, two camshafts 5, 6, and, for example, two inlet valves 7, 8 and two outlet valves 9, 10 per cylinder. The inlet valves 7, 8 and the outlet valves 9, 10 are housed in a V-shaped manner in a cylinder head (not shown) of the internal-combustion engine 1. The two camshafts 5, 6 are connected with one another by way of an endless drive 11. The endless drive may be a belt or chain wound around corresponding drive wheels. The endless drive is coupled with a crankshaft, which is not shown, and is operative adjacent to faces 12, 13 of the above-mentioned camshafts. Devices 14, 15 for hydraulicly adjusting the relative rotating position of these camshafts are coaxially connected to the faces 12, 13 of the camshafts 5, 6. Each device such as the device 14 is constructed as a vane cell pump. The timing of the valves 7, 8 is influenced by each device in order to optimize the operation of the internal-combustion engine 1, among other things, with respect to exhaust emissions.

The device 14 has a circular-cylindrical configuration and constructionally corresponds to the device 15. The device 14 has a drive wheel 16 constructed as a chain wheel for the camshaft 5, a cell wheel 17 and an impeller 19 equipped with radial vanes 18. The drive wheel 16, the cell wheel 17 and the impeller 19 are arranged coaxially with respect to the camshaft 5. The drive wheel 16 and the cell wheel 17 form a firmly mutually connected constructional unit 20. In contrast, the impeller 19, which can be rotated about an axis of rotation 21, is housed by the vanes 18. The vanes are able to carry out a relative motion in chamber-type cells 22 of the cell wheel 17. A total of five cells per device is provided. Each cell 22 is equipped with a first stop face 23 and a second stop face 24 for corresponding first and second stop faces 25, 26 of a vane 18. All stop faces 23, 24 and 25, 26 extend radially with respect to the axis of rotation 21, but the angle α, which is enclosed by the stop faces 23, 24, is larger than the corresponding angle β of the stop faces 25, 26 of the vane 18.

The cell 22 is also bounded by a circular surface 27. A circular surface 28 of the vane 18 extends toward the circular surface 27. Both circular surfaces 27 and 28 act as sealing surfaces. At reference number 29, circular surfaces 30, 31, forming comparable sealing surfaces, are provided between the impeller 19 and the cell wheel 17. Adjacent to the circular surfaces 27 and 30, the contact surfaces 23, 24 are provided with chamber-shaped recesses 32, 33 and 34, 35 by way of which hydraulic medium is admitted for acting upon the stop faces 25, 26 of the vane 18 of the impeller 19.

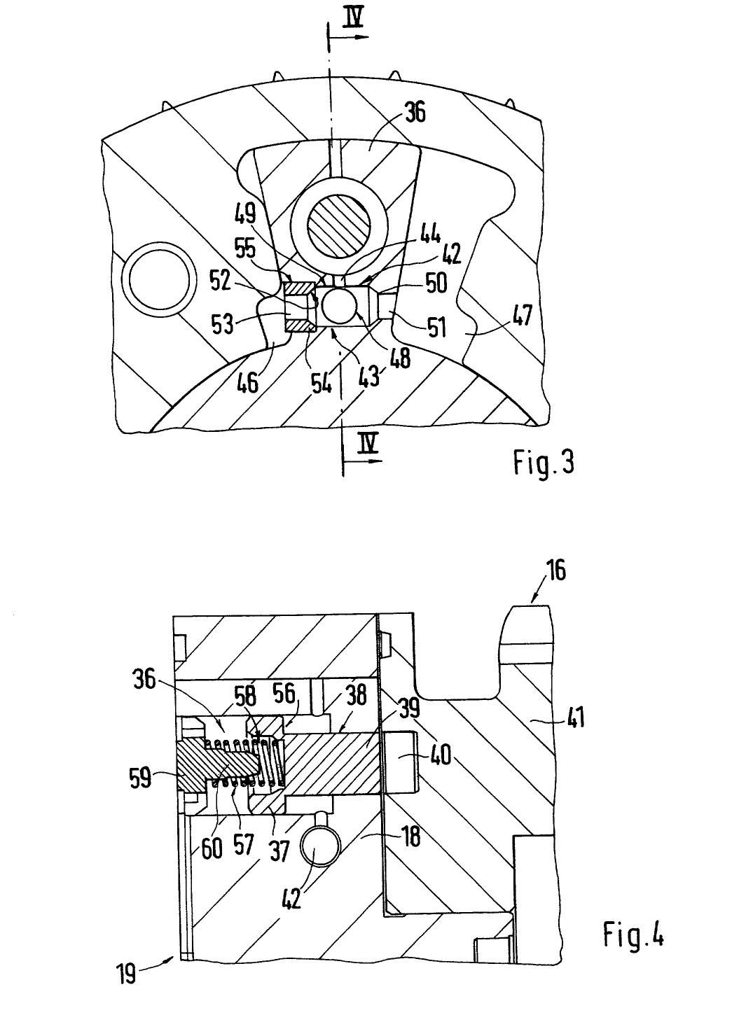

In the starting phase of the internal-combustion engine 1, the impeller 19 is fixed on the constructional unit 20 formed by the drive wheel 16 and the cell wheel 17, for the purpose of which a locking arrangement 36 is set up. The locking arrangement 36 comprises a piston 37, shown in FIG. 4, which is slidable in a bore 38 of the vane 18 of the impeller 19 in the axial direction of the axis of rotation 21 and cooperates, by way of a locking pin 39, with a corresponding receiving device 40 in a hub body 41 of the constructional unit 20. The piston 37 is made in one piece with the locking pin 39. The piston is acted upon from a pressure duct 42, shown in FIG. 3, extending approximately tangentially in the vane 18. In the pressure duct 42, a reversal valve 43 is operative. The pressure duct 42 is connected by way of a radial bore 44 to a pressure space 45 of the piston 37. The reversal valve 43 is connected with pressure spaces 46 and 47 of the impeller 19 which are provided on both sides of the stop faces 25, 26 of the vane 18. Hydraulic medium is fed from pressure spaces 46 and 47 of the impeller 19.

The reversal valve 43 has a ball 48 which is guided for relative motion in the pressure duct 42. The pressure duct 42 has a guide bore 49 for the ball 48. In addition, the pressure duct 42 is bounded by a first bevel 50 of a first end bore 51 and by a second bevel 52 of a second end bore 53. The diameter of the guide bore 49 is larger than the diameter of the end bores 51 and 53, and the bevels 50 and 52 are used as valve seats for the ball 48. The second end bore 53 and the second bevel 52 are provided on an insert 54 which is fixed in an insert bore 55 with a diameter which is larger than the diameter of the guide bore 49. By way of the insert 54, the ball 48 is placed in the guide bore 49.

The locking pin 39 of the piston 37, which interacts with the receiving device 40, has a smaller diameter than the diameter of the piston 37. As a result, a ring pressure surface 56 is provided which can be acted upon by hydraulic medium. On the side of the piston 37 facing away from the locking pin 39, a pressure spring 57 is supported. This pressure spring rests in areas in a recess 58 of the piston 37, which forms a type of head of the locking pin 39, and is supported on a spring plate 59 which is fixed in the bore 38 for the piston 37. The spring plate 59 is provided with a guide pin 60 which is surrounded in sections by the pressure spring 57.

When the internal-combustion engine is not in operation, its hydraulic system, including the device 14, is without pressure. As a result, the pressure spring 57 holds the locking pin 29 in position in the receiving device 40 and a relative movement of the impeller 19 in the cell wheel 17 for adjustment of the camshaft 7 cannot take place. This condition is at first maintained in the starting phase of the internal-combustion engine 1 with a defined pressure level in the hydraulic system. After this pressure level has been exceeded, the ring pressure surface 56 is acted upon by hydraulic medium and the locking pin 39 is led out of the receiving device 40 against the effect of the pressure spring 57. The impeller 19, or rather the camshaft 5, can now be adjusted as a function of parameters (rotational speed, load) of the internal-combustion engine 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A camshaft for operation of valves of an internal-combustion engine, comprising:
a device for hydraulic adjustment of a relative rotating position of the camshaft for influencing a timing of the valves, said device having a drive wheel for the camshaft, a cell wheel, and an impeller which can carry out a relative motion and is disposed with radial blades within cells of the cell wheel,
a locking arrangement which acts in a starting phase of the internal-combustion engine provided between the cell wheel and the impeller, said locking arrangement being formed by an axial spring-loaded, hydraulically operated piston housed in one of the blades of the impeller and a corresponding receiving device for the piston provided in a constructional unit consisting of the drive wheel and the cell wheel,
the piston housed in said one of the blades, which cooperates with the corresponding receiving device, being acted upon from a pressure duct of the one of the blades, and
a reversal valve, operative in said pressure duct, which is connected to pressure spaces of one of the cells.

2. The camshaft according to claim 1, wherein the pressure duct in the blade extends approximately tangentially between the pressure spaces.

3. The camshaft according to claim 1, wherein the reversal valve comprises a ball which is axially movably guided in the pressure duct.

4. The camshaft according to claim 3, wherein the pressure duct comprises a guide bore for the ball, wherein said guide bore is bounded on one side by a first bevel and a first end bore and, on another side, by a second bevel and a second end bore, and wherein the second bevel is provided on, and the second end bore is provided in, an insert which is inserted into an insert bore of the pressure duct.

5. The camshaft according to claim 4, wherein the first end bore has a smaller diameter than the guide bore, and wherein the insert bore has a larger diameter than the guide bore.

6. The camshaft according to claim 1, wherein the piston has a locking pin on one side which interacts with the corresponding receiving device and, on the other side, is supported on a pressure spring.

7. The camshaft according to claim 6, wherein one side of the pressure spring is inserted into a recess of the piston and the other side of the pressure spring is supported on a spring plate.

8. The camshaft according to claim 7, wherein the spring plate has a guide pin which is surrounded by the pressure spring.
